(19) United States
(12) Patent Application Publication
(10) Pub. No.: US 2015/0224894 A1
(43) Pub. Date: Aug. 13, 2015

(54) METHOD FOR DIAGNOSING FUEL CELL STACK

(71) Applicant: Hyundai Motor Company, Seoul (KR)

(72) Inventors: Ja Hoo KOO, Yongin-si (KR); Sang Uk KWON, Suwon-si (KR)

(21) Appl. No.: 14/470,304

(22) Filed: Aug. 27, 2014

(30) Foreign Application Priority Data
Feb. 13, 2014 (KR) 10-2014-0016556

(51) Int. Cl. B60L 11/18; B60L 3/12; H01M 8/04; G07C 5/08

(52) U.S. Cl. CPC B60L 11/1881; G07C 5/0808; B60L 3/12; H01M 8/04559; H01M 8/04589; H01M 2250/20

(57) ABSTRACT

A method for diagnosing a fuel cell includes measuring a current and a voltage of a fuel cell stack while a fuel cell vehicle operates and sequentially storing the measured current and voltage. Whether or not the fuel cell vehicle operates at a constant current based on the stored current is determined. The measured current of the fuel cell stack is changed by driving any one of external current consumption apparatuses if it is determined based on the determination result that the fuel cell vehicle operates at the constant current.

### CROSS-REFERENCE(S) TO RELATED APPLICATION

The present application claims the benefit of priority to Korean Patent Application Number 10-2014-0016556 filed on Feb. 13, 2014, the entire contents of which application is incorporated herein for all purposes by this reference.

### TECHNICAL FIELD

The present disclosure relates to a method for diagnosing a fuel cell stack, and more particularly, to a method for diagnosing a fuel cell stack capable of using a curve-fitting method while a fuel cell vehicle operates at a constant current.

### BACKGROUND

A fuel cell vehicle includes a fuel cell stack in which a plurality of fuel cells used as a power source are stacked. A fuel supply system supplies hydrogen or the like as fuel to the fuel cell stack. An air supply system supplies oxygen, as an oxidizing agent required for an electrochemical reaction. A water and heat management system controls a temperature of the fuel cell stack. The fuel supply system reduces pressure of compressed hydrogen inside a hydrogen tank and supplies the compressed hydrogen to an anode of the stack, and the air supply system supplies external air through an air blower to a cathode of the stack.

When hydrogen is supplied to the anode of the stack and oxygen is supplied to the cathode, hydrogen ions are separated at the anode by a catalyst reaction. The separated hydrogen ions are transferred to the cathode through an electrolyte membrane, and the hydrogen ions separated at the anode electrochemically react with electrons and oxygen in the cathode to obtain electric energy. In detail, hydrogen is electrochemically oxidized in the anode, and oxygen is electrochemically reduced in the cathode. At this time, electricity and heat are generated due to the transfer of the generated electrons, and water or water vapor is generated by a chemical action which combines hydrogen with oxygen.

A discharge apparatus is provided to discharge hydrogen, oxygen, and the like which do not react with byproducts such as vapor, water and water vapor, and heat which are generated during the generation of electric energy by the fuel cell stack, and gases such as water vapor, hydrogen, and oxygen are discharged to the air through an exhaust path. Components such as an air blower, a hydrogen recirculation blower, and a water pump for driving the fuel cell are connected to a main bus terminal to facilitate a starting of the fuel cell. Various kinds of relays for facilitating power cut-off and connection to the main bus terminal and a diode for preventing a reverse current from flowing in the fuel cell may be connected to the main bus terminal.

Dry air supplied through the air blower is humidified by a humidifier and then is supplied to the cathode of the fuel cell stack. Exhaust gas of the cathode is transferred to the humidifier in a state in which the exhaust gas is humidified by the water component generated inside the fuel cell stack and transferred to the humidifier, and thus may be used to humidify the dried air to be supplied to the cathode by the air blower.

The fuel cell stack sensitively responds to operating conditions, such as external temperature, cooling water temperature, and current, and thus, the state and performance thereof are determined. When driving of the vehicle is continued in a situation in which the operation conditions are poor, the performance of the fuel cell stack is degraded in the short term. Therefore, the fuel cell stack may not meet a required output of a driver, and a long term durability of the stack is deteriorated, and thus, the lifespan of the fuel cell stack is shortened.

A dry out of the stack is caused by two factors. One is a dry out which occurs at high temperature and high output, and another is a dry out which occurs at low output. The dry out at the high temperature and high output may occur due to a loss of heat balance inside the stack, and the dry output at the low output may occur due to excessively supplied air. When the dry out of the fuel cell stack occurs, the output of the fuel cell stack is reduced and it takes much time to recover the output of the fuel cell stack to a normal output. Therefore, there is a need to sense the dry out situation of the fuel cell stack and perform a stack recovering operation in case of the dry out situation to perform a control to implement a rapid recovery.

When the dry out of the fuel cell stack occurs, an ohmic resistance loss value is increased. A method for measuring an ohmic resistance loss value may be classified into an AC impedance method, a current cut-off method, and a curve-fitting method. The AC impedance method and the current cut-off method directly change a value of current flowing in the fuel cell stack to measure a variation or a voltage phase, and the curve-fitting method measures a current-voltage value used when the fuel cell vehicle is driven without changing the current, so as to be used after a signal is processed.

### SUMMARY

The present disclosure provides a method for diagnosing a fuel cell stack capable of diagnosing the fuel cell stack using a curve-fitting method while a fuel cell vehicle operates at a constant current.

According to an exemplary embodiment, a method for diagnosing a fuel cell stack includes measuring a current and a voltage of the fuel cell stack while a fuel cell vehicle operates and sequentially storing the measured current and voltage. Whether or not the fuel cell vehicle operates at a constant current based on the stored current is determined. The measured current of the fuel cell stack is changed by driving any one of external current consumption apparatuses if it is determined that the fuel cell vehicle operates based on a determination result.

In the step of determining whether or not the fuel cell vehicle operates at a constant current, it may be determined whether the fuel cell vehicle operates at the constant current based on the stored dispersion value of current.

It may be determined that the fuel cell vehicle operates at the constant current when the stored dispersion value of current is smaller than a reference value.

The method for diagnosing a fuel cell stack may further include measuring an internal resistance value using a curve-fitting method based on the changed current.

The external current consumption apparatuses may be a load and a motor.

In the step of changing the current, when a temperature of any one of the external current consumption apparatuses is equal to or greater than a reference temperature, the current may be changed using the current consumption apparatus other than any one of the external current consumption apparatuses.

In the step of changing the current, the current may be changed by turning on/off an operation of any one of the external current consumption apparatuses.

In the step of changing the current, a controller controlling the external current consumption apparatuses may change power consumption of the external current consumption apparatuses.

### BRIEF DESCRIPTION OF THE DRAWINGS

The above and other objects, features and advantages of the present disclosure will be more clearly understood from the following detailed description taken in conjunction with the accompanying drawings.

FIG. 1 is a flow chart illustrating a method for diagnosing a fuel cell stack according to an embodiment of the present disclosure.

FIG. 2 is a diagram schematically illustrating a connection relationship between the fuel cell stack according to an embodiment of the present disclosure and external current consumption apparatuses.

### DETAILED DESCRIPTION

Specifically structural and functional descriptions in exemplary embodiment of the present disclosure disclosed in the present specification or the present application are illustrated to describe exemplary embodiments of the present disclosure, and therefore, exemplary embodiments may be practiced in various forms and are not to be construed as being limited to the exemplary embodiment of the present disclosure disclosed in the present specification or the present application.

The exemplary embodiments may be variously modified and have various forms and therefore specific exemplary embodiments are illustrated in the accompanying drawings and will be described in detail in the present specification or the present application. However, it is to be understood that the present disclosure is not limited to the specific exemplary embodiments, but includes all modifications, equivalents, and substitutions included in the spirit and the scope of the present disclosure.

Terms such as ‘first’, ‘second’, etc., may be used to describe various components, but the components are not to be construed as being limited to the terms. The terms are used only to distinguish one component from another component. For example, the ‘first’ component may be named the ‘second’ component and the ‘second’ component may also be similarly named the ‘first’ component, without departing from the scope of the present disclosure.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween. Other expressions describing a relationship between components, that is, “between”, “directly between”, “neighboring to”, “directly neighboring to” and the like, should be similarly interpreted.

Terms used in the present specification are used only in order to describe specific exemplary embodiments rather than Is limiting the present disclosure. Singular forms are intended to include plural forms unless the context clearly indicates otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

Unless indicated otherwise, it is to be understood that all the terms used in the specification including technical and scientific terms have the same meaning as those that are understood by those who skilled in the art. It must be understood that the terms defined by the dictionary are identical with the meanings within the context of the related art, and they should not be ideally or excessively formally defined unless the context clearly dictates otherwise.

Hereinafter, exemplary embodiments will be described in detail with reference to the accompanying drawings. Like reference numerals proposed in each drawing denote like components.

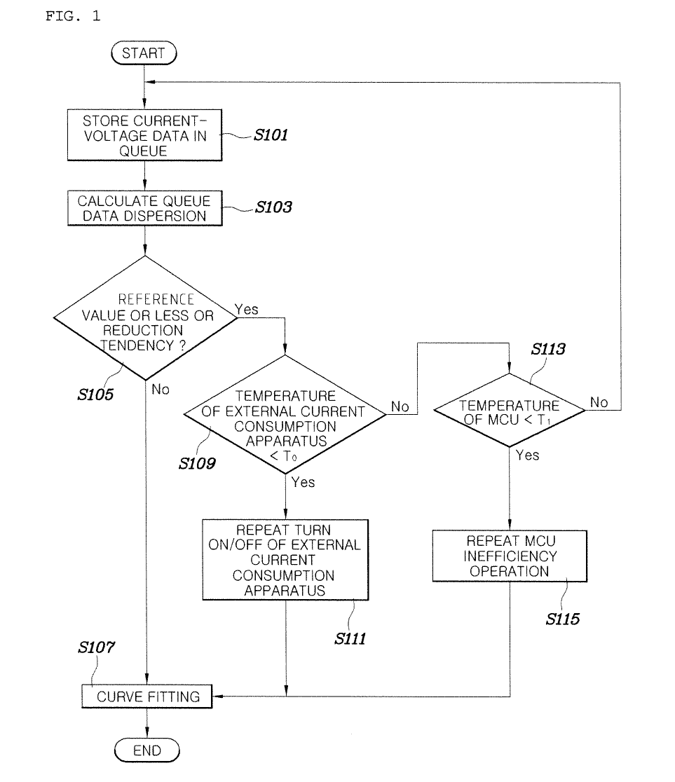

FIG. 1 is a flow chart illustrating a method for diagnosing a fuel cell stack according to an embodiment. The method for diagnosing a fuel cell according to the embodiment may include measuring a current and a voltage of the fuel cell stack while a fuel cell vehicle operates and sequentially storing the measured current and voltage. Whether or not the fuel cell vehicle operates at a constant current based on the stored current is determined. The measured current of the fuel cell stack is changed by driving any one of the external current consumption apparatuses if it is determined based on the determination result that the fuel cell vehicle operates for the constant current.

In detail, the current and voltage of the fuel cell stack may be stored in a queue having a set size while the fuel cell vehicle operates (S101). The size of the queue may be determined in consideration of an analysis accuracy of data of current and voltage values and a memory capacity of the fuel cell vehicle.

A dispersion value of the current value and the voltage value of the fuel cell stack which are stored in the queue may be calculated (S103).

The determination on whether the fuel cell vehicle currently operates at the constant current may be based on the stored dispersion value of current. That is, in step S103, when the calculated dispersion value of current is equal to or less than a reference value or tends to be reduced, it may be determined that the fuel cell vehicle operates at the constant current. When the calculated dispersion value of current is equal to or greater than the reference value or tends to be increased, it may be determined that the fuel cell vehicle is not driven at the constant current. That is, when the dispersion value of the current stored in the queue is calculated, and the calculated dispersion value is smaller than the reference value, it may be determined that the fuel cell vehicle operates at the constant current. When the calculated dispersion value is larger than the reference value, it may be determined that the fuel cell vehicle is not being driven at the constant current. By presetting the range in which the fuel cell vehicle operates at the constant current based on the size of the dispersion value, it may be determined that the fuel cell vehicle operates at the constant current when the dispersion value is in the corresponding range, and it may be determined that the fuel cell vehicle does not drive at the constant current when the dispersion value is out of the corresponding range.

If it is determined that the fuel cell vehicle is not operating at the constant current, the internal resistance value may be analyzed using the curve-fitting method in the relationship between the current and the output voltage (S107).

To the contrary, if it is determined that the fuel cell vehicle operates at the constant current, the curve-fitting method may not be used, and therefore, the current output from the fuel cell stack may be changed by driving any one of the external current consumption apparatuses (S111 and S115). By changing the current of the fuel current stack from driving any one of the external current consumption apparatuses, the internal resistance value may be analyzed using the curve-fitting method. Further, the state of the current fuel cell stack may be determined by analyzing the internal resistance value.

In this case, when the temperature of any one of the external current consumption apparatuses is equal to or higher than a reference temperature T₀ when measuring the temperature of the external current consumption apparatuses, the output current of the fuel cell stack may be changed by using the remaining current consumption apparatuses other than any one of the external current consumption apparatuses (S115). When the temperature of any one of the external current consumption apparatuses is less than the reference temperature T₀, the current output from the fuel cell stack may be changed by turning on/off an operation of any one of the external current consumption apparatuses, and thus, the internal resistance value may be analyzed using the curve-fitting method.

FIG. 1 illustrates a motor driven by determining whether the temperature of the external current consumption apparatus is higher than the reference temperature T₀, and if so, determines whether a temperature of a motor control unit (MCU) is higher than a reference temperature T₁. This is only an example of the present disclosure, and therefore the motor control unit may not drive the motor, but other current consumption apparatuses may drive the motor and steps S113 and S115 may be performed followed by steps S109 and S111. When the temperature of all the external current consumption apparatuses is higher than the reference temperatures of each apparatus, the step of storing the current and voltage values of the fuel cell stack in the queue having a set size while the fuel cell vehicle again operates is repeated (S101).

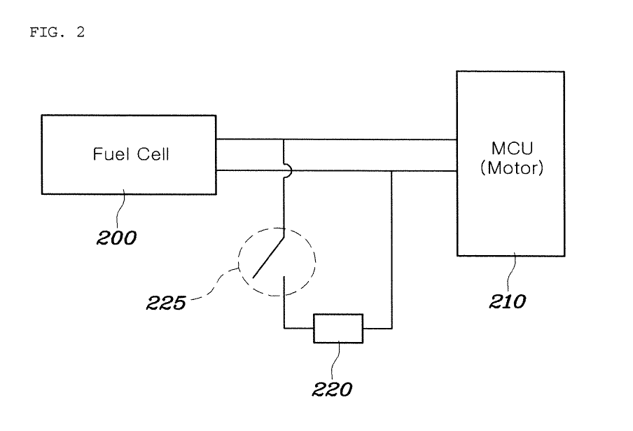

FIG. 2 is a diagram schematically illustrating a connection relationship between the fuel cell stack according to an exemplary embodiment and external current consumption apparatuses.

That is, the fuel cell stack 200 may be connected to a load 220 through a switch 225 and may be connected to a motor control unit (MCU) 210 which controls the motor. When the fuel cell vehicle may not use the curve-fitting method, the external current consumption apparatus (load) 220 is connected to the fuel cell stack 200 to turn on/off the operation of the current consumption apparatuses, thereby changing the current value output from the fuel cell stack 200.

Alternatively, the controller (for example, motor control unit of FIG. 2) which controls the external current consumption apparatuses changes the consumption current of the external current consumption apparatuses to change the current value output from the fuel cell stack 200. In the case of the MCU 210, a current quantity consumed at a constant rotating speed may be controlled by controlling the motor driving efficiency of the MCU 210. Therefore, the internal resistance may be analyzed using the curve-fitting method under the condition that the fuel cell vehicle operates at a constant speed.

According to the method for diagnosing a fuel cell stack in accordance with the embodiment of the present disclosure, it is possible to analyze the resistance value inside the fuel cell stack using the curve-fitting method while the fuel cell vehicle operates at the constant current.

Although the present disclosure has been described with reference to the embodiments shown in the accompanying drawings, they are only examples. It will be appreciated by those skilled in the art that various modifications and equivalent other embodiments are possible from the present disclosure. Accordingly, the actual technical protection scope of the present disclosure must be determined by the spirit of the appended claims.

What is claimed is:

1. A method for diagnosing a fuel cell stack, comprising steps of:
measuring a current and a voltage of the fuel cell stack while a fuel cell vehicle operates and sequentially storing the measured current and voltage;
determining whether the fuel cell vehicle operates at a constant current based on the stored current; and
changing the measured current of the fuel cell stack by driving any one of external current consumption apparatuses if it is determined based on a determination result that the fuel cell vehicle is operating.

2. The method of claim 1, wherein in the step of determining whether the fuel cell vehicle operates at a constant current, it is determined whether the fuel cell vehicle operates at the constant current based on the stored dispersion value of current.

3. The method of claim 2, wherein it is determined that the fuel cell vehicle operates at constant current when the stored dispersion value of current is smaller than a reference value.

4. The method of claim 1, further comprising a step of:
measuring an internal resistance value using a curve-fitting method based on the changed current.

5. The method of claim 1, wherein the external current consumption apparatuses are a load and a motor.

6. The method of claim 1, wherein in the step changing the current, when a temperature of any one of the external current consumption apparatuses is equal to or greater than a reference temperature, the current is changed using the current consumption apparatus other than any one of the external current consumption apparatuses.

7. The method of claim 1, wherein in the step of changing the current, the current is changed by turning on/off an operation of any one of the external current consumption apparatuses.

8. The method of claim 1, wherein in the step of changing the current, a controller controlling the external current consumption apparatuses changes power consumption of the external current consumption apparatuses.
